(19) United States
(12) Patent Application Publication
(10) Pub. No.: US 2024/0300523 A1
(43) Pub. Date: Sep. 12, 2024

(54) DRIVING SUPPORT SYSTEM AND TRAVELING CONTROL DEVICE

(71) Applicant: HITACHI ASTEMO, LTD., Hitachinaka-shi, Ibaraki (JP)

(72) Inventors: Daniel GABRIEL, Tokyo (JP); Yuki HORITA, Tokyo (JP); Hidehiro TOYODA, Hitachinaka-shi (JP)

(73) Assignee: HITACHI ASTEMO, LTD., Hitachinaka-shi, Ibaraki (JP)

(21) Appl. No.: 18/258,358

(22) PCT Filed: Sep. 22, 2021
(86) PCT No.: PCT/JP2021/034897

§ 371 Date: Jun. 20, 2023

(30) Foreign Application Priority Data
Dec. 25, 2020 (JP) 2020-216199

(51) Int. Cl. B60W 60/00; B60W 30/09; B60W 30/095; B60W 50/14

(52) U.S. Cl. CPC B60W 60/001; B60W 30/09; B60W 30/0953; B60W 30/0956; B60W 50/14; B60W 2554/4041

(57) ABSTRACT

A driving support system includes a storage unit that stores a plurality of pieces of invasion event information including information on an invasion position where a moving object invades a traveling region, the invasion event information being information on an invasion event in which the moving object invades the traveling region, an invasion frequent occurrence region calculation unit that specifies an invasion frequent occurrence region which is a region where the invasion event easily occurs based on the plurality of pieces of invasion event information, a position specification unit that specifies a position of the vehicle, and a driving support unit that supports driving of the vehicle by notifying an occupant of the vehicle and controlling traveling of the vehicle based on a relationship between the invasion frequent occurrence region and the position of the vehicle.

### TECHNICAL FIELD

The present invention relates to a driving support system and a traveling control device.

### BACKGROUND ART

In recent years, in order to implement comfortable and safe driving support and autonomous driving of a vehicle, there has been proposed a technique for determining a risk latent in a blind spot region of a sensor that recognizes a surrounding environment of the vehicle. For example, PTL 1 discloses an event prediction system that includes an accumulation unit that accumulates a plurality of pieces of learning data including history information indicating a situation of a moving object when an event related to driving of the moving object occurs, and a generation unit that generates a prediction model for predicting relative coordinates of an occurrence place of the event with respect to the moving object by using the plurality of pieces of learning data. Each of the plurality of pieces of learning data further includes label information indicating the relative coordinates of the occurrence place of the event with respect to the moving object.

### CITATION LIST

### Patent Literature

PTL 1: JP 2018-120290 A

### SUMMARY OF INVENTION

### Technical Problem

In the invention described in PTL 1, there is a possibility of excessively predicting an event.

### Solution to Problem

A driving support system according to a first aspect of the present invention is a driving support system that supports driving of a vehicle. The driving support system includes a storage unit that stores a plurality of pieces of invasion event information including information on an invasion position where a moving object invades a traveling region, the invasion event information being information on an invasion event in which the moving object invades the traveling region, an invasion frequent occurrence region calculation unit that specifies an invasion frequent occurrence region which is a region where the invasion event easily occurs based on the plurality of pieces of invasion event information, a position specification unit that specifies a position of the vehicle, and a driving support unit that supports the driving of the vehicle by notifying an occupant of the vehicle and controlling traveling of the vehicle based on a relationship between the invasion frequent occurrence region and the position of the vehicle.

A traveling control device according to a second aspect of the present invention is a traveling control device mounted on a vehicle. The traveling control device includes a position specification unit that specifies a position of the vehicle, an invasion event specification unit that detects an invasion event in which a moving object invades a traveling region, and records the invasion event information including information on an invasion position where the moving object invades the lane region, an invasion frequent occurrence region calculation unit that specifies an invasion frequent occurrence region which is a region where the invasion event easily occurs based on the plurality of pieces of invasion event information, and a driving support unit that supports driving of the vehicle by notifying an occupant of the vehicle or controlling traveling of the vehicle based on a relationship between the invasion frequent occurrence region and the position of the vehicle.

### Advantageous Effects of Invention

According to the present invention, it is possible to support the driving of the vehicle at the place where the vehicle has invaded the lane in the past.

### BRIEF DESCRIPTION OF DRAWINGS

FIG. 1 is a functional block diagram of a driving support system 1.

FIG. 2 is a functional block diagram of a traveling control device 100 according to a first embodiment.

FIG. 3 is a diagram illustrating an example of an invasion frequent occurrence region data group 136.

FIG. 4 is a diagram illustrating an example of an invasion risk data group 137.

FIG. 5 is a diagram illustrating a correlation between functions implemented by the traveling control device 100 and a server 4.

FIG. 6 is a flowchart illustrating knowledge acquisition processing in the traveling control device.

FIG. 7 is a flowchart illustrating knowledge acquisition processing in the server.

FIG. 8 is a flowchart illustrating risk calculation processing in the traveling control device.

FIG. 9 is a flowchart illustrating risk calculation processing in the server.

FIG. 10 is a diagram illustrating a first operation example.

FIG. 11 is a diagram illustrating the first operation example.

FIG. 12 is a diagram illustrating the first operation example.

FIG. 13 is a diagram illustrating a second operation example.

FIG. 14 is a diagram illustrating the second operation example.

FIG. 15 is a diagram illustrating the second operation example.

FIG. 16 is a functional block diagram of a traveling control device 100A according to a second embodiment.

### DESCRIPTION OF EMBODIMENTS

### First Embodiment

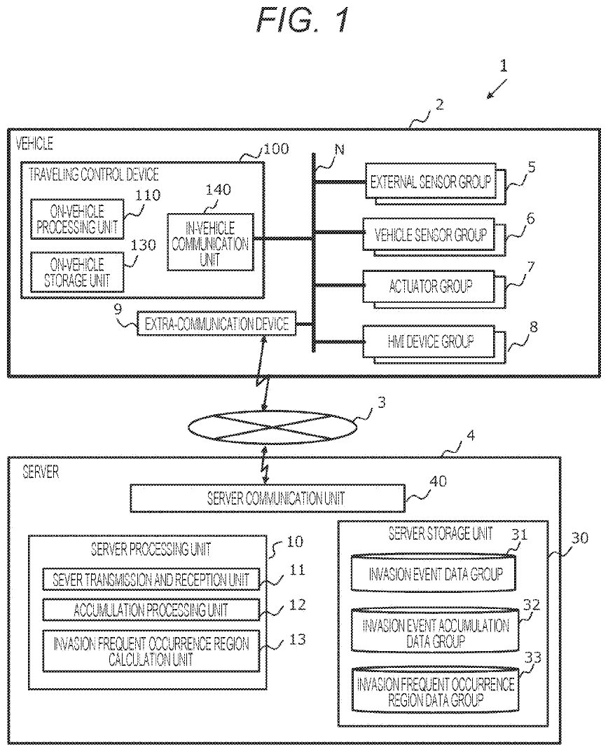

Hereinafter, a first embodiment of a driving support system will be described with reference to FIGS. 1 to 15. In the present embodiment, a predetermined region where one vehicle travels in a width direction is referred to as a “lane”. The lane is also referred to as a “lane” or a “traveling lane”.

### (System Configuration)

FIG. 1 is a functional block diagram illustrating a configuration of a driving support system 1 including a vehicle 2 and a server 4 according to an embodiment of the present invention. Note that, although only one vehicle 2 is described in FIG. 1 for the sake of convenience in drawing, a plurality of vehicles 2 may be connected to the server 4.

A traveling control device 100 of the vehicle 2 recognizes a situation of an obstacle such as a traveling road or a peripheral vehicle around the vehicle 2, and then performs appropriate driving support and traveling control. The server 4 stores and accumulates a part of data acquired and processed by the traveling control device 100 of the vehicle 2, further processes the data, and then transmits the processed data to the traveling control device 100 of the vehicle 2. Communication between the traveling control device 100 of the vehicle 2 and the server 4 is performed via a network 3. The network 3 includes, for example, a combination of an infrastructure network to which the server 4 is connected and an edge network such as a wireless LAN, a mobile communication network, or a power line communication network for accessing the infrastructure network from the vehicle 2.

As illustrated in FIG. 1, the vehicle 2 includes the traveling control device 100, external sensor groups 5, vehicle sensor groups 6, actuator groups 7, HMI device groups 8, and an extra-vehicle communication device 9. The traveling control device 100, the external sensor groups 5, the vehicle sensor groups 6, the actuator groups 7, the HMI device groups 8, and the extra-vehicle communication device 9 are connected by an on-vehicle network N. Note that, hereinafter, the vehicle 2 may be referred to as a “host vehicle” 2 in order to be distinguished from other vehicles.

The traveling control device 100 is an electronic control unit (ECU). The traveling control device 100 generates traveling control information for driving support or autonomous driving of the vehicle 2 based on various kinds of input information provided from the external sensor groups 5, the vehicle sensor groups 6, the server 4, and the like, and outputs the traveling control information to the actuator groups 7 and the HMI device groups 8. The traveling control device 100 includes an on-vehicle processing unit 110, an on-vehicle storage unit 130, and an in-vehicle communication unit 140.

The on-vehicle processing unit 110 includes, for example, a central processing unit (CPU) which is a central arithmetic processing unit. However, in addition to the CPU, a graphics processing unit (GPU), a field-programmable gate array (FPGA), an application specific integrated circuit (ASIC), or the like may be included, or any one thereof may be included.

The external sensor group 5 is an assembly of devices that detect a state around the vehicle 2. The external sensor group 5 corresponds to, for example, a camera device, a millimeter wave radar, LiDAR, sonar, or the like. The external sensor group 5 detects environmental elements such as an obstacle, a road marking, a sign, and a signal in a predetermined range from the vehicle 2, and outputs the environmental elements to the on-vehicle network N. The “obstacle” is, for example, another vehicle that is a vehicle other than the vehicle 2, a pedestrian, a falling object on a road, a road edge, or the like. A “moving object” which is one type of obstacle handled in the present invention is a moving dynamic obstacle excluding a stationary object. The “road marking” is, for example, a white line, a crosswalk, a stop line, or the like. Furthermore, the external sensor group 5 also outputs information regarding a detection state to the on-vehicle network N based on a sensing range and a state of the external sensor group.

The vehicle sensor group 6 is an assembly of devices that detect various states of the vehicle 2. Each vehicle sensor detects, for example, position and posture information of the vehicle 2, a traveling speed, a steering angle, an operation amount of an accelerator, an operation amount of a brake, and the like, and outputs the detected information to the on-vehicle network N. The vehicle sensor group 6 includes a global navigation satellite system (GNSS) receiver, and an output of the vehicle sensor group 6 includes a position of the vehicle 2 in a geographic coordinate system, that is, latitude and longitude. The actuator group 7 is a device group that controls control elements such as steering, braking, and an accelerator that determine the movement of the vehicle. The actuator group 7 controls the movement of the vehicle based on operation information of a steering wheel, a brake pedal, an accelerator pedal, and the like by a driver and control information output from the traveling control device 100.

The HMI device group 8 is a device group for inputting information from a driver or an occupant to the traveling control device 100, notifying the driver or the occupant of information from the traveling control device 100, outputting a warning regarding a risk of hindering the traveling of the vehicle 2, and the like. The HMI device group 8 includes a display, a speaker, a vibrator, a switch, and the like. The extra-vehicle communication device 9 is a communication module that performs wireless communication with an outside of the traveling control device 100. For example, the extra-vehicle communication device is configured to be able to communicate with the server 4, the Internet, and the like.

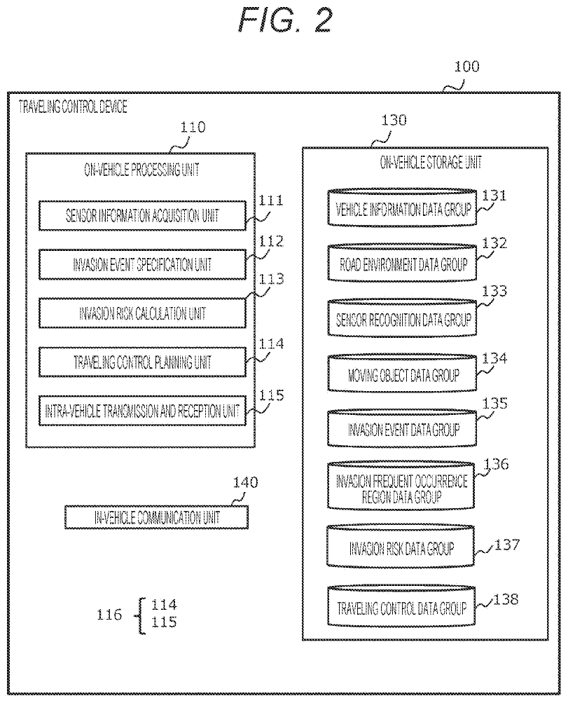

FIG. 2 is a diagram illustrating a detailed configuration of the traveling control device 100. The on-vehicle processing unit 110 includes, as functions thereof, a sensor information acquisition unit 111, an invasion event specification unit 112, an invasion risk calculation unit 113, a traveling control planning unit 114, and an intra-vehicle transmission and reception unit 115. The on-vehicle processing unit 110 implements these functions by executing a predetermined operation program stored in the on-vehicle storage unit 130. Note that, hereinafter, the traveling control planning unit 114 and the intra-vehicle transmission and reception unit 115 will be collectively referred to as a driving support unit 116.

The sensor information acquisition unit 111 acquires various kinds of information from other devices connected to the traveling control device 100 via the on-vehicle network N, and stores the information in the on-vehicle storage unit 130. The sensor information acquisition unit 111 stores, as a moving object data group 134, information regarding a current position, a moving direction, and the like at the time of detecting the moving object around the vehicle 2 detected by the external sensor group 5.

The sensor information acquisition unit 111 stores an output of the external sensor group 5 as a sensor recognition data group 133. Furthermore, the sensor information acquisition unit 111 integrates the outputs of the external sensor groups 5 to calculate a blind spot region which is a region around the vehicle 2 which cannot be recognized by the external sensor group 5, and stores information on the blind spot region as the sensor recognition data group 133. The blind spot region is a region where the sensor exceeds a detection limit thereof or a region where the moving object or the like cannot be detected by a shielding object. The blind spot region can be calculated, for example, as a set of a region behind an object detected by each sensor and a region where each sensor exceeds a detection limit determined from a specification of each sensor. Since the sensor information acquisition unit 111 calculates the blind spot region in this manner, the sensor information acquisition unit can be referred to as a “blind spot calculation unit”.

The sensor information acquisition unit 111 stores, as a road environment data group 132, data regarding a travel environment, for example, information for specifying a lane such as a white line or a road edge, among the outputs of the external sensor group 5. However, the sensor information acquisition unit 111 may not only output the output of the external sensor group 5 as it is as the road environment data group 132, but may also output different kinds of data in combination as the road environment data group 132. The sensor information acquisition unit 111 stores, as a vehicle information data group 131, information regarding the movement, the state, and the like of the vehicle 2 detected by the vehicle sensor group 6 and the like. Further, since the sensor information acquisition unit 111 acquires positional information of the vehicle 2 from the vehicle sensor group 6, the sensor information acquisition unit can also be referred to as a “position specification unit” that specifies the position of the vehicle 2.

The invasion event specification unit 112 specifies an invasion event in which a moving object around the vehicle 2 has invaded into a lane region based on the road environment data group 132 and the moving object data group 134 acquired by the sensor information acquisition unit 111. The lane invasion of the moving object indicates that information on the moving object detected around the vehicle 2, for example, the moving object position, the moving direction, and the like are moving from an outside of the lane region into the lane region with respect to the lane region or the like of the road.

The lane region is, for example, a road region considering a width of a general vehicle and the like by law, and is a region where the general vehicle can travel without hindering traveling of other vehicles, and is not necessarily a region explicitly indicated by a white line or the like. The outside of the lane region corresponds to, for example, a region outside the road region (sidewalk, grass on a roadside, or the like), a road edge in the road region, a region where traveling is prohibited, another lane region other than the lane region, and the like. That is, a behavior of moving from a certain lane region to another lane region such as a lane change, a behavior of invading a different road by turning right or left from a road having a different direction at an intersection or the like, and the like can also be specified as the invasion event. A position of the specified invasion event in the geographic coordinate system is specified based on the vehicle information data group 131 acquired by the sensor information acquisition unit 111. The geographic coordinate system is, for example, longitude and latitude, and is a coordinate system that can uniquely express a specific place on the earth.

The invasion risk calculation unit 113 calculates an invasion risk of the moving object invading from the blind spot to the lane region. The invasion risk indicates, for example, a degree of risk of a potential moving object invading the lane region from the outside of the lane region. The invasion risk may be expressed by, for example, a grid map such as an occupancy grid map (OGM) or the like in a region where there is a high invasion risk of the moving object around the vehicle 2. The invasion risk calculation unit 113 calculates an invasion risk from a positional relationship between an invasion frequent occurrence region present around a host vehicle and a blind spot region which is a blind spot of a sensor mounted on the host vehicle. Details are as follows.

The invasion risk calculation unit 113 recognizes a position, a speed, and a posture of the host vehicle and an object present around the host vehicle based on the vehicle information data group 131 and the sensor recognition data group 133 acquired by the sensor information acquisition unit 111. In a case where the invasion frequent occurrence region data group 136 received from the server 4 overlaps with the blind spot region that cannot be recognized by the sensor, an invasion risk is calculated.

The traveling control planning unit 114 plans a trajectory on which the vehicle 2 is to travel based on the invasion risk or the like generated by the invasion risk calculation unit 113, and determines a control command value to be output to the actuator group 7 for following the planned trajectory. The intra-vehicle transmission and reception unit 115 outputs various kinds of information to other devices connected to the traveling control device 100 via the on-vehicle network N. In addition, the invasion event data group 135 specified by the invasion event specification unit 112 is transmitted to the server 4 through the extra-vehicle communication device 9, and the invasion frequent occurrence region data group 136 is received from the server 4.

Further, for example, the traveling control device 100 outputs the control command value determined by the traveling control planning unit 114 to the actuator group 7 to control the traveling of the vehicle 2. Further, for example, the traveling control device 100 may output the sensor recognition data group 133, the invasion risk generated by the invasion risk calculation unit 113, the planned trajectory generated by the traveling control planning unit 114, and the like to the HMI device group 8. Furthermore, the traveling control device 100 may present interpretation of the travel environment in the driving support system 1 under autonomous control by displaying the sensor recognition data group 133 and the invasion risk, or may present to the occupant what kind of travel is planned by displaying plan activation.

The on-vehicle storage unit 130 includes, for example, a storage device such as a hard disk drive (HDD), a flash memory, and a read only memory (ROM), and a memory such as a random-access memory (RAM). The on-vehicle storage unit 130 stores a program processed by the on-vehicle processing unit 110, a data group necessary for the processing, and the like. In addition, as a main storage when the on-vehicle processing unit 110 executes the program, the on-vehicle storage unit is also used for temporarily storing data necessary for arithmetic processing of the program. In the present embodiment, the vehicle information data group 131, the road environment data group 132, the sensor recognition data group 133, the moving object data group 134, the invasion event data group 135, the invasion frequent occurrence region data group 136, an invasion risk data group 137, a traveling control data group 138, and the like are stored as information for implementing the functions of the traveling control device 100.

The vehicle information data group 131 is a set of data regarding the movement, the state, and the like of the vehicle 2. The vehicle information data group 131 includes vehicle information detected by the vehicle sensor group 6 and the like acquired by the sensor information acquisition unit 111, the traveling control information generated by the traveling control planning unit 114, and the like. The vehicle information includes, for example, information such as a position, a posture, a traveling speed, a steering angle, an operation amount of an accelerator, an operation amount of a brake, and a traveling route of the vehicle 2.

The road environment data group 132 is a set of data regarding the travel environment of the vehicle 2. The data regarding the travel environment includes, for example, information regarding shapes and attributes (traveling direction, speed limit, traveling limit, and the like) of a road on which the vehicle 2 is traveling and lanes constituting the road. The shape and attribute information of the road and the lanes are included in, for example, a result of fusion of a plurality of kinds of data acquired from the external sensor group 5 and the like.

The sensor recognition data group 133 is a set of detection information by the external sensor group 5 or data regarding the detection state. The detection information is, for example, information regarding environmental elements such as an obstacle, a road marking, a sign, and a signal specified by the external sensor group 5 based on the sensing information. The detection state is information indicating a region detected by the sensor and accuracy thereof, and includes, for example, a grid map such as an OGM, and can express the blind spot region or the like.

The moving object data group 134 is detection information for a moving obstacle around the vehicle 2 by the external sensor group 5. The detection information of the moving object includes, for example, relative positional information of the obstacle with respect to the vehicle 2 detected by the external sensor group 5, information obtained by calculating a moving direction, a moving speed, an acceleration, and the like of the moving object by continuously detecting a plurality of frames, a classification label (pedestrian, vehicle, or the like) of the moving object by a recognition algorithm from point group information of LiDAR, and the like.

The invasion event data group 135 is a set of a state and a behavior of a moving object, event specification information, and the like which are generated by the invasion event specification unit 112 and are necessary for calculating the invasion frequent occurrence region data group 136. The state of the moving object is, for example, the positional information in the moving object in the geographic coordinate system, the classification information (pedestrian, vehicle, or the like) of the moving object, or the like. The behavior of the moving object is, for example, the moving direction, the speed, the acceleration, and the like of the moving object. The event specification information is a characteristic element associated with the occurrence of the event, for example, additional information such as a time zone in which the event has occurred.

The invasion frequent occurrence region data group 136 is a set of information including a combination of a geographical region where the invasion event frequently occurs and the invasion event, and is calculated based on an invasion event history. The geographical region is expressed by, for example, origin coordinates or the like for being able to be specified by a shape of the region or a geographic coordinate system. The invasion frequent occurrence region data group is generated by an invasion frequent occurrence region calculation unit 13 of the server 4 based on an invasion event accumulation data group 32 of the server 4.

The invasion risk data group 137 is information regarding a degree of risk of collision with a potential moving object around the vehicle 2 calculated by the invasion risk calculation unit 113. For example, the degree of risk at each position around the vehicle 2 is expressed by a grid map such as an OGM. The traveling control data group 138 is a data group regarding plan information for controlling the traveling of the vehicle 2, and includes the planned trajectory of the vehicle 2, the control command value to be output to the actuator group 7, and the like.

The in-vehicle communication unit 140 includes, for example, a network card or the like conforming to a communication standard such as IEEE 802.3 or a controller area network (CAN). The in-vehicle communication unit 140 transmits and receives data to and from other devices in the vehicle 2 based on various protocols. Note that, in the present embodiment, although the in-vehicle communication unit 140 and the on-vehicle processing unit 110 are separately described, a part of processing of the in-vehicle communication unit 140 may be executed in the on-vehicle processing unit 110. For example, it may be configured such that a hardware device in communication processing may be positioned in the in-vehicle communication unit 140, and other device driver groups, communication protocol processing, and the like may be positioned in the on-vehicle processing unit 110. Referring back to FIG. 1, the description is continued.

The server 4 receives and manages the invasion event data group 135 provided from the vehicle 2. In addition, the invasion frequent occurrence region is calculated by using the invasion event data group 135 accumulated from the past to the present, and the event frequent occurrence region related to the vehicle 2 is extracted and transmitted to the vehicle 2 in accordance with a request from the vehicle 2. The server 4 includes a server processing unit 10, a server storage unit 30, and a server communication unit 40.

The server processing unit 10 includes, for example, a CPU which is a central arithmetic processing unit. However, in addition to the CPU, a GPU, an FPGA, an ASIC, or the like may be included, or any one of these components may be included. The server processing unit 10 includes, as functions thereof, a server transmission and reception unit 11, an accumulation processing unit 12, and the invasion frequent occurrence region calculation unit 13. The on-vehicle processing unit 110 implements these functions by executing a predetermined operation program stored in the server storage unit 30.

The server transmission and reception unit 11 transmits a part of the invasion frequent occurrence region data group 33 calculated by the invasion frequent occurrence region calculation unit 13 to the traveling control device 100 of the vehicle 2. In addition, the server transmission and reception unit 11 receives the invasion event data group 135 from the traveling control device 100 of the vehicle 2 and stores the invasion event data group 31 in the server storage unit 30. The accumulation processing unit 12 transforms information on a region included in the invasion event data group 31 into a geographic coordinate system and stores the information as the invasion event accumulation data group 32.

The invasion frequent occurrence region calculation unit 13 creates the invasion frequent occurrence region data group 33 using the invasion event accumulation data group 32, and stores the invasion frequent occurrence region data group 33 in the server storage unit 30. A procedure of creating the invasion frequent occurrence region data group 33 is, for example, as follows. The invasion frequent occurrence region calculation unit 13 first reads the invasion event accumulation data group 32 and extracts pieces of event data close to each other in the geographic coordinate system to specify a region where the invasion event frequently occurs. Subsequently, the invasion frequent occurrence region calculation unit 13 calculates the shape, the origin coordinates, a moving object invasion frequency, and the like of the region. In addition, the invasion frequent occurrence region calculation unit 13 calculates a classification, a moving direction, a moving speed, an invasion frequency, and the like of a representative moving object invading the region by statistical processing, and stores the information in the server storage unit 30 as the invasion frequent occurrence region data group 33.

The server storage unit 30 includes, for example, a storage device such as an HDD, a flash memory, and a ROM, and a memory such as a RAM. The server storage unit 30 stores a program processed by the server processing unit 10, a data group necessary for the processing, and the like. In addition, as a main storage when the server processing unit 10 executes the program, the server storage unit is also used for temporarily storing data necessary for arithmetic processing of the program.

The server storage unit 30 stores, as information for implementing the functions of the server 4, the invasion event data group 31, the invasion event accumulation data group 32, and the invasion frequent occurrence region data group 33.

The invasion event data group 31 is the same kind of information as the invasion event data group 135 of the traveling control device 100 of the vehicle 2. However, since the invasion event data group 135 is transmitted from the plurality of vehicles 2 to the server 4, the invasion event data group 31 has a larger amount than the invasion event data group 135. The invasion event accumulation data group 32 is information accumulated by processing the invasion event data group 31. Specifically, there is a difference that information on an invasion region is described as a relative position from the host vehicle 2 in the invasion event data group 31, but the information on the invasion region is represented by the geographic coordinate system in the invasion event accumulation data group 32. The invasion frequent occurrence region data group 33 is the same kind of information as the invasion frequent occurrence region data group 136 stored in the traveling control device 100 of the vehicle 2.

The server communication unit 40 is a communication module that performs wireless communication with an outside of the server 4. For example, the server communication unit is configured to be able to communicate with the traveling control device 100 of the vehicle 2, the Internet, and the like.

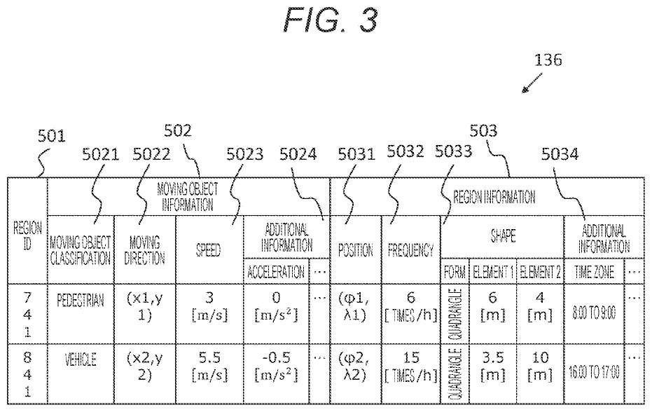

FIG. 3 is a diagram illustrating an example of the invasion frequent occurrence region data group 136. As described above, the invasion frequent occurrence region data group 136 is a set of invasion frequent occurrence region data. The invasion frequent occurrence region data group 136 has a plurality of records, and each record corresponds to invasion frequent occurrence region data. The records of the invasion frequent occurrence region data group 136 include fields of a region ID 501, moving object information 502, and region information 503. An identifier for identifying the invasion frequent occurrence region is stored in the region ID 501. Information on a moving object having a highest frequency of invading the invasion frequent occurrence region is stored in the moving object information 502. The moving object information 502 includes a moving object classification 5021, a moving direction 5022, a speed 5023, and additional information 5024. However, the additional information 5024 is any information, and the presence or absence of registration may be different for each record.

In the moving object classification 5021, information indicating the classification of the moving object is stored, and a character string may be stored as illustrated in FIG. 3, or an identifier or a label indicating the classification of the moving object may be stored. Information indicating the moving direction of the moving object is stored in the moving direction 5022. As illustrated in FIG. 3, the moving direction may be expressed by a vector of XY coordinates in which east is a positive direction of an X axis and north is a positive direction of a Y axis, or the traveling direction may be expressed by characters such as “southwest” and “north east”.

Information on the speed of the moving object is input to the moving speed 5023. Note that the speed mentioned herein is not a relative speed with respect to the host vehicle but an absolute speed, in other words, a relative speed between the ground and the moving object. In the additional information 5024, information for further finely classifying the invasion event such as the acceleration of the moving object may be stored, and may be stored with any added expression as necessary.

The region information 503 includes a position 5031, a frequency 5032, a shape 5033, and additional information 5034. However, the additional information 5034 is any information, and the presence or absence of registration may be different for each record. Information on latitude and longitude of a representative point that can specify the region in a map coordinate system, for example, a center point of the region is stored in the position 5031. In the frequency 5032, information on a frequency of invasion of the moving object into the region is stored, and is specifically represented as the number of times of invasion per hour.

A combination of information for specifying a name and a dimension of the shape of the region is stored in the shape 5033. For example, a first record in FIG. 3 indicates that the shape is a quadrangle with side lengths of 6 m and 4 m. Note that, although not illustrated in FIG. 3, in a case where the shape of the region is “circle”, information indicating the dimension is one of radii. Information for distinguishing the invasion event from other invasion events, such as a time zone in which the invasion event occurs in the region is stored in the additional information 5034.

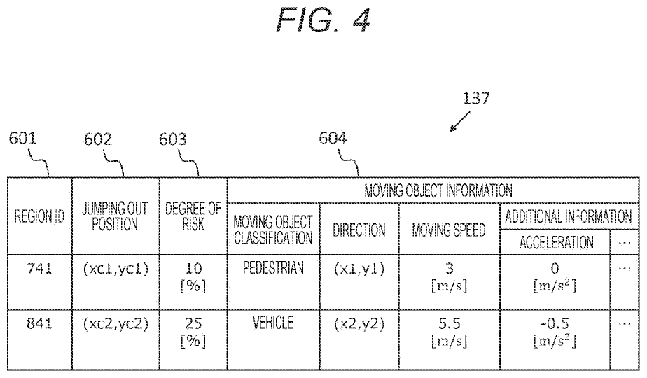

FIG. 4 is a diagram illustrating an example of the invasion risk data group 137. As described above, the invasion risk data group 137 is a set of invasion risk data. The invasion risk data group 137 includes a plurality of records, and each record corresponds to invasion risk data. The records of the invasion risk data group 137 include fields of a region ID 601, a jumping out position 602, a degree of risk 603, and moving object information 604. Similarly to the region ID 501 illustrated in FIG. 3, an identifier for identifying an invasion frequent occurrence region is stored in the region ID 601.

Information for specifying a jumping out position in a case where the moving object jumps out of the blind spot region is stored in the jumping out position 602. The jumping out position 602 is set in the invasion frequent occurrence region and the blind spot region. The jumping out position 602 is expressed by relative coordinates of the moving object with respect to the vehicle 2. The jumping out position 602 may be set at a position closest to the vehicle 2 on a boundary line between the blind spot region and the region detectable by the sensor in order to ensure the safety of traveling of the vehicle 2.

A magnitude of risk, for example, a probability that the moving object will cause the invasion event is stored in the degree of risk 603. The degree of risk 603 is calculated based on the frequency 5032 of the invasion frequent occurrence region data group 136. The degree of risk 603 is expressed by, for example, a value of 0% to 100%, and in a case where the value is low, the risk of the moving object invading the lane is expressed as low, and in a case where the value is high, the risk of the moving object invading the lane is expressed as high. Information on a moving object assumed to jump out from the blind spot region, that is, information similar to the moving object information 502 described in FIG. 3 is stored in the moving object information 604.

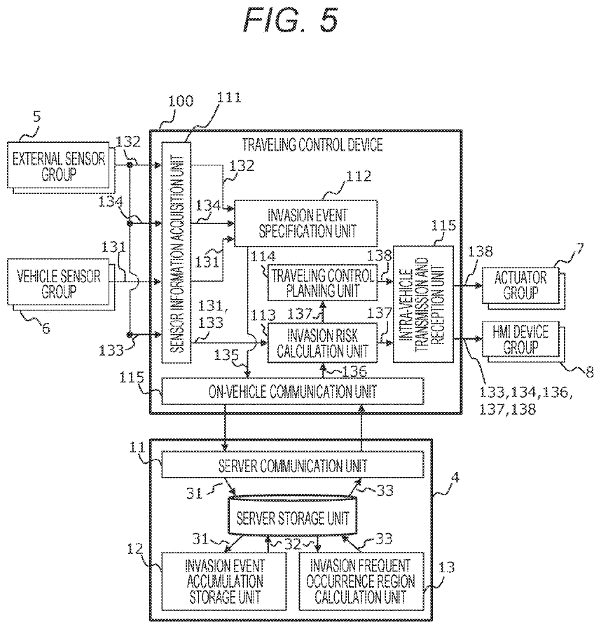

An operation of the driving support system 1 will be described with reference to FIGS. 5 to 9. The traveling control device 100 of the vehicle 2 specifies an event in which the moving object present around the vehicle 2 invades the lane in cooperation with the server 4 based on information acquired from the external sensor group 5 and the like, creates the invasion event data group 135, and transmits the invasion event data group to the server 4. The server 4 creates the invasion frequent occurrence region data group 33 by using the invasion event data group 135 and transmits the created invasion frequent occurrence region data group to the traveling control device 100. The traveling control device 100 determines the risk of the moving object jumping out of the blind spot region into the lane by using the output of the external sensor group 5 and the invasion frequent occurrence region data group 136 acquired from the server. Further, the traveling control device 100 outputs a warning against the risk or generates and outputs the traveling control information of the vehicle 2.

The actuator group 7 controls the actuators of the vehicle 2 according to the traveling control information output from the traveling control device 100, and the traveling control of the vehicle 2 is implemented. In addition, the traveling control device 100 generates HMI information as information to be notified to the driver and the occupant, such as a warning regarding the risk of hindering the traveling of the vehicle 2 and information presentation regarding the traveling control of the vehicle 2, and outputs the HMI information to the HMI device group 8. Accordingly, it is possible to urge safe driving by causing the driver to warn about the traveling risk and to present the state of the driving support system 1 during autonomous traveling to the driver or the occupant.

FIG. 5 is a diagram illustrating a correlation between the functions implemented by the traveling control device 100 and the server 4. The traveling control device 100 is configured such that kinds of processing of the sensor information acquisition unit 111, the invasion event specification unit 112, the invasion risk calculation unit 113, the traveling control planning unit 114, and the intra-vehicle transmission and reception unit 115 are executed in order. The server 4 includes the server transmission and reception unit 11, the accumulation processing unit 12, and the invasion frequent occurrence region calculation unit 13. The cooperation between the traveling control device 100 and the server 4 is implemented, for example, by mutually transmitting data between the in-vehicle communication unit 140 and the server transmission and reception unit 11. The series of processing are periodically executed, for example, every 100 ms.

The sensor information acquisition unit 111 of the traveling control device 100 acquires necessary information from other devices via the on-vehicle network N, and stores the acquired information in the on-vehicle storage unit 130. The road environment data group 132, the sensor recognition data group 133, and the moving object data group 134 are acquired from the external sensor group 5, and the vehicle information data group 131 is acquired from the vehicle sensor group 6 and is delivered to a processing unit in a subsequent stage.

The invasion event specification unit 112 of the traveling control device 100 specifies that the moving object has invaded the lane based on the position, the moving direction, and the like of the moving object present around the vehicle 2 by using the road environment data group 132 and the moving object data group 134. For example, in a case where data is periodically collected, in a case where positional information of a certain moving object acquired in a previous cycle is outside the lane region and positional information of the moving object acquired in a next cycle is inside the lane region, the invasion event specification unit specifies that the moving object has invaded the lane region. Since the invasion event is determined for each lane, the outside of the lane region represents the outside of the road region, a lane region different from the lane currently analyzed, or the like.

Further, since the road environment data group 132 and the moving object data group 134 are information on relative positions with respect to the vehicle 2, the invasion event specification unit 112 specifies a position of the specified invasion event information in the geographic coordinate system based on the vehicle information data group 131 acquired by the sensor information acquisition unit 111. For example, the position of the vehicle 2 in the geographic coordinate system is specified by the output of the GNSS receiver mounted on the vehicle 2, and the position of the lane or the moving object in the geographic coordinate system is calculated from a relative positional relationship with the vehicle 2. The event information specified in the geographic coordinate system is stored as the invasion event data group 135 and is output to the intra-vehicle transmission and reception unit 115.

The intra-vehicle transmission and reception unit 115 of the traveling control device 100 transmits the invasion event data group 135 specified by the invasion event specification unit 112 to the server 4. Further, the invasion frequent occurrence region data group 33 is received from the server 4, and is stored as the invasion frequent occurrence region data group 136 in the on-vehicle storage unit 130 of the traveling control device 100.

The invasion risk calculation unit 113 of the traveling control device 100 collates the invasion frequent occurrence region with the blind spot region acquired from the sensor recognition data group 133 based on the invasion frequent occurrence region data group 136 acquired by the intra-vehicle transmission and reception unit 115, the vehicle information data group 131 and the sensor recognition data group 133 acquired by the sensor information acquisition unit 111, and calculates the invasion risk. The blind spot regions represented by the OGM or the like from geometric information or the like of the representative point and shape of the lane invasion frequent occurrence region are collated, and thus, a probability of jumping out from the blind spot region (degree of risk), a jumping direction, geometric information of a jumping out moving object, and the like are stored as the invasion risk data group 137 based on the information such as the moving object classification, the moving direction, and the invasion frequency stored in the invasion frequent occurrence region data group 136, and are output to the traveling control planning unit 114 and the intra-vehicle transmission and reception unit 115.

The traveling control planning unit 114 of the traveling control device 100 plans a trajectory of traveling control of the vehicle 2 based on the invasion risk data group 137 acquired by the invasion risk calculation unit 113, and generates the control command value or the like for following the trajectory. The planned trajectory, the control command value, and the like of the vehicle 2 are output to the intra-vehicle transmission and reception unit 115 as the traveling control data group 138.

The intra-vehicle transmission and reception unit 115 of the traveling control device 100 outputs the control command value to the actuator group 7 based on the traveling control data group 138 acquired from the traveling control planning unit 114. Further, the HMI device group 8 outputs the information to be presented to the occupant based on the sensor recognition data group 133 and the moving object data group 134 acquired from the sensor information acquisition unit 111, the invasion frequent occurrence region data group 136 received from the server 4, the invasion risk data group 137 acquired from the invasion risk calculation unit 113, and the traveling control data group 138 acquired from the traveling control planning unit 114.

The server transmission and reception unit 11 of the server 4 receives the invasion event data group 135 from the traveling control device 100 and outputs the invasion event data group to the accumulation processing unit 12. In addition, the invasion frequent occurrence region data group 33 calculated by the invasion frequent occurrence region calculation unit 13 is transmitted to the traveling control device 100.

The accumulation processing unit 12 of the server 4 stores, as the invasion event accumulation data group 32, the invasion event data group 31 output from the server transmission and reception unit 11. In a case where the invasion event accumulation data group 32 is already present and new event data is acquired, the accumulation processing unit 12 accumulates the data in the invasion event accumulation data group 32.

The invasion frequent occurrence region calculation unit 13 of the server 4 calculates the shape, the origin coordinates, the moving object invasion frequency, and the like of the region where the invasion event frequently occurs from the pieces of event data close to each other in the geographic coordinate system based on the invasion event accumulation data group 32 accumulated by the accumulation processing unit 12. In order to calculate the information on the frequent occurrence region from the invasion event accumulation data group 32, the invasion frequent occurrence region calculation unit 13 may perform processing at designated intervals in advance to discretize the accumulated data in the geographic coordinate system. For example, the accumulated event data may be divided for each interval of the geographic coordinate system designated in advance like a grid, and an average of the shape of the region, the moving object information, and the like of the event data in the same grid may be calculated, or representative information of the frequent occurrence region may be obtained by using another statistical means.

In addition, based on the characteristic of the event data such as the positional information in the geographic coordinate system, the invasion frequent occurrence region calculation unit 13 may group mutual nearby events based on a predetermined clustering method, and may generate the information on the frequent occurrence region by using a predetermined statistical means in each group. The invasion frequent occurrence region calculation unit 13 stores, as the invasion frequent occurrence region data group 33, the information such as the calculated shape, origin coordinates, moving object invasion frequency, representative moving direction of the moving object in the invasion frequent occurrence region, moving speed, moving object classification, and the like in the server storage unit 30.

### (Invasion Frequent Occurrence Region Calculation Processing and Invasion Risk Calculation Processing)

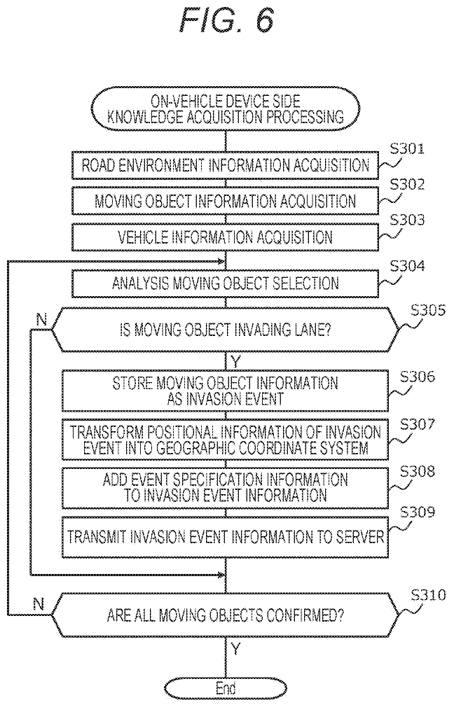

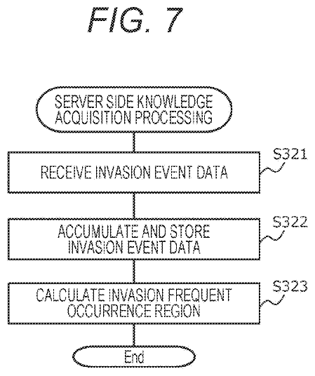

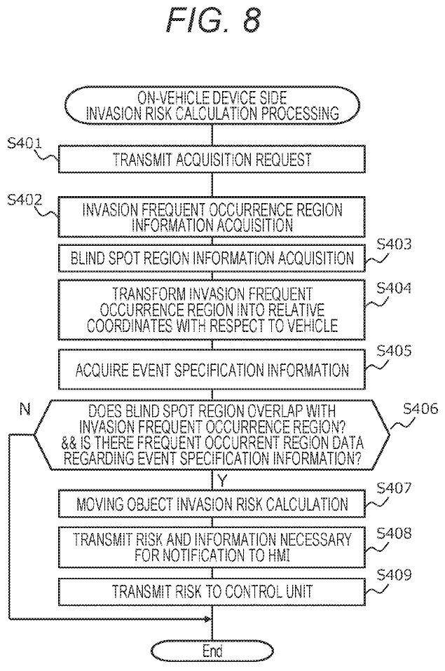

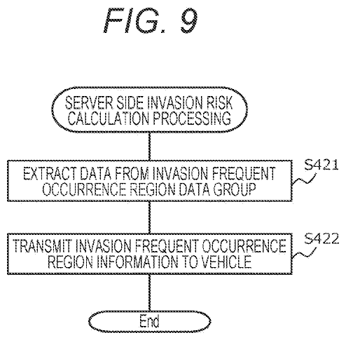

FIGS. 6 to 9 are diagrams illustrating an example of a flowchart for implementing the processing illustrated in FIG. 5. FIG. 5 roughly includes two kinds of processing, and these kinds of processing are executed asynchronously with each other. FIGS. 6 and 7 illustrate knowledge acquisition processing of specifying and acquiring knowledge about the invasion event around the traveling vehicle 2. FIGS. 8 and 9 illustrate risk calculation processing of calculating a risk of the moving object jumping out of the blind spot region around the traveling vehicle 2 based on the invasion event information acquired as the knowledge. Each of the knowledge acquisition processing and the risk calculation processing is implemented by cooperation between the traveling control device 100 and the server 4. FIGS. 6 and 8 illustrate the processing executed by the traveling control device 100, and FIGS. 7 and 9 illustrate the processing executed by the server 4.

FIG. 6 is a flowchart illustrating the knowledge acquisition processing executed by the traveling control device 100. First, in steps S301 and S302, the sensor information acquisition unit 111 acquires road environment information and moving object information around the vehicle 2 from the external sensor group 5. The moving object information is, for example, information regarding all moving objects around the vehicle 2. In subsequent step S303, the sensor information acquisition unit 111 acquires vehicle information including the position and posture information of the vehicle 2 in the geographic coordinate system from the vehicle sensor group 6, and the processing proceeds to step S304.

In step S304, in order to analyze the acquired behaviors of all the moving objects, the invasion event specification unit 112 sequentially selects the moving objects for all the moving objects acquired in step S302. In FIG. 6, the processing in and after step S304 is processing for the moving object selected herein.

In subsequent step S305, the invasion event specification unit 112 determines whether or not the moving object has invaded the lane based on the road environment information and the moving object information. Specifically, for example, in a case where the position of the moving object is on the lane region and a position of a previous frame of the moving object is outside the lane region, it is determined that the moving object has invaded the lane. In addition, for example, the lane invasion may be determined based on the position and the moving direction of the moving object. In a case where it is determined that the lane invasion has occurred, the processing proceeds to step S306, and in a case where it is determined that the lane invasion has not occurred, the processing proceeds to step S310.

In step S306, the invasion event specification unit 112 stores, as the invasion event data group 135, information on the moving object determined to invade the lane in S305. Specifically, the positional information, the moving direction, the moving speed, and the like of the moving object are stored.

In subsequent step S307, the invasion event specification unit 112 transforms the positional information of the invasion event data group 135 stored in step S306 into the geographic coordinate system based on the position and posture information of the vehicle 2 acquired in S303. Since the positional information of the moving object of the invasion event data group 135 is acquired from the external sensor group 5 of the vehicle 2, the positional information is relative positional information with respect to the vehicle 2. The relative positional information is, for example, information on a coordinate value in a coordinate system having a center of the vehicle 2 as an origin. The invasion event specification unit 112 may replace the relative positional information in the invasion event data group 135 with the positional information in the geographic coordinate system, or may add the positional information in the geographic coordinate system without deleting the relative positional information.

In subsequent step S308, the invasion event specification unit 112 further adds event specification information such as an event occurrence time to the invasion event data group 135. The event specification information is, for example, additional information such as occurrence time of an event, an acceleration of a moving object, facility information around an event occurrence place, and the like. The event specification information is used for, for example, additional processing. In subsequent step S309, the intra-vehicle transmission and reception unit 115 transmits the invasion event data group 135 to the server 4 via the extra-vehicle communication device 9, and the processing proceeds to step S310.

In step S310, the invasion event specification unit 112 determines whether or not all moving objects detected around the vehicle 2 have been analyzed. In a case where it is determined that the analysis of all the moving objects is completed, the processing illustrated in FIG. 6 is ended, and in a case where it is determined that there is a moving object that has not been analyzed yet, the processing returns to step S304 and continues.

FIG. 7 is a flowchart illustrating the knowledge acquisition processing executed by the server 4. First, in step S321, the server transmission and reception unit 11 receives, as the invasion event data group 31, the invasion event data group 135 transmitted by the traveling control device 100 in S309. In subsequent step S322, the accumulation processing unit 12 stores the invasion event data group 31 as the invasion event accumulation data group 32 in the server storage unit 30 of the server 4. Note that, in a case where the invasion event accumulation data group 32 is already present and the invasion event data group 31 is newly acquired, the invasion event data group 31 is added to the existing invasion event accumulation data group 32. Since all invasion event data groups 31 acquired in the past are accumulated, it can be said that the invasion event accumulation data group 32 is history information of the invasion event data group 31.

Finally, in S323, the invasion frequent occurrence region calculation unit 13 calculates the invasion frequent occurrence region based on the invasion event accumulation data group 32 accumulated in step S322, and stores the invasion frequent occurrence region as the invasion frequent occurrence region data group 33. In the invasion frequent occurrence region, for example, the region where the invasion event frequently occurs is determined based on the invasion event accumulation data groups 32 close to each other in the geographic coordinate system, and the shape, the origin coordinates, the moving object invasion frequency, and the like of the region are calculated. In addition, a tendency is calculated from the estimated invasion event accumulation data group 32 in the region by a statistical method or the like of the moving object state, the behavior, or the like, and the classification, the moving direction, the moving speed, the invasion frequency, or the like of the representative moving object is associated with the frequent occurrence region.

Specifically, for example, in a case where the moving speed of the moving object in a certain frequent occurrence region A is statistically large at five meters per second in the past event data, the moving speed of the representative moving object in the frequent occurrence region A is set as five meters per second. Furthermore, the event specification information and the like may also be set, and for example, the occurrence time of the event, the facility information around the event occurrence place, and the like may also be associated. Based on these pieces of information, for example, the frequent occurrence region can be provided for each time, and a tendency of the invasion event for each time zone can be expressed. Specifically, for example, in a case where many invasion events occur between 8:00 AM and 9:00 AM in a specific place B but an event does not occur between 12:00 and 13:00, the frequent occurrence region may be set only in a case where the vehicle travels in the specific place B between 8:00 AM and 9:00 AM.

Note that FIG. 7 illustrates that the processing in step S323 is executed immediately after step S322, but the present invention is not limited thereto. For example, periodic batch processing such as collecting a plurality of pieces of event data in a certain time and then performing processing at once may be executed asynchronously with S322.

FIG. 8 is a flowchart illustrating the risk calculation processing executed by the traveling control device 100. First, in step S401, the sensor information acquisition unit 111 acquires positional information of the vehicle 2 in the geographic coordinate system from the vehicle sensor group 6, and transmits, as an acquisition request that is a request for the invasion frequent occurrence region data group 33 around the vehicle 2, geographic coordinate system positional information of the vehicle 2 including the positional information to the server 4. In subsequent step S402, the intra-vehicle transmission and reception unit 115 receives the invasion frequent occurrence region data group 33 from the server 4, and stores the invasion frequent occurrence region data group as the invasion frequent occurrence region data group 136 in the on-vehicle storage unit 130.

In subsequent step S403, the sensor information acquisition unit 111 acquires various kinds of information from the external sensor group 5 and stores the acquired information as the sensor recognition data group 133. Furthermore, the sensor information acquisition unit 111 creates the information on the blind spot regions by using the acquired various kinds of information and adds the information to the sensor recognition data group 133.

In subsequent step S404, the invasion risk calculation unit 113 performs coordinate transformation of the received invasion frequent occurrence region data group 136 based on the vehicle information acquired in step S401. The received positional information of the invasion frequent occurrence region data group 136 is expressed in the geographic coordinate system, whereas the blind spot region information acquired in step S403 is expressed by the relative position with respect to the vehicle 2. In order to collate the invasion frequent occurrence region with the blind spot region in subsequent step S406, the expression of the positional information in the invasion frequent occurrence region data group 136 is transformed into a relative coordinate system with the vehicle 2 as an origin. Based on the positional information in the geographic coordinate system, the positional information of the invasion frequent occurrence region can be transformed into the relative coordinate system with respect to the vehicle 2 by parallel movement and rotation.

In subsequent step S405, for example, the event specification information, in other words, the additional information used for subsequent processing, such as a current time when the vehicle 2 travels, is acquired. In subsequent step S406, the invasion risk calculation unit 113 determines whether or not to execute risk calculation processing of the blind spot region. Specifically, in a case where the invasion risk calculation unit 113 determines that there is data of the invasion frequent occurrence region corresponding to the event specification information acquired in step S405 and the blind spot region and the invasion frequent occurrence region overlap with each other, the processing proceeds to step S407. In a case where the invasion risk calculation unit 113 determines that there is no data of the invasion frequent occurrence region corresponding to the event specification information acquired in step S405 or the blind spot region and the invasion frequent occurrence region do not overlap with each other, the processing illustrated in FIG. 8 is ended.

Note that, in a case where there are a plurality of invasion frequent occurrence region data groups 136 around the vehicle 2 received from the server 4, all the invasion frequent occurrence region data groups 136 received in step S402 are collated with all blind spot regions around the vehicle 2. For example, it is possible to determine whether or not the invasion frequent occurrence region data group overlaps with the positional information of the blind spot region on the OGM based on the position and shape information of the frequently entered region.

In step S407, the invasion risk calculation unit 113 calculates the invasion risk of the potential moving object into the lane from the blind spot region, in other words, the risk of the moving object jumping out, based on the blind spot region information acquired in step S403 and the invasion frequent occurrence region data group 136 received from the server 4. For example, the invasion risk calculation unit 113 sets at least one of the classification, the moving direction, the moving speed, the event specification information, a jumping out start position, and the degree of risk of the moving object having a possibility of jumping out based on the invasion frequent occurrence region data group 136.

The jumping out start position is set, for example, in a region where the invasion frequent occurrence region and the blind spot region overlap with each other. For example, the degree of risk may be calculated from the moving object invasion frequency stored in the invasion frequent occurrence region information, and may be calculated based on a statistical event occurrence rate of the past history. For example, in a case where invasion events have occurred at a frequency of N times/1 h (N times per hour) in a place A in the past, and invasion events have occurred at a frequency of M times/1 h in another place B in the past, and N>M, the degree of risk calculated based on the invasion frequent occurrence region of the place A is larger than the degree of risk calculated based on the invasion frequent occurrence region of the place B. The calculated invasion risk is stored as the invasion risk data group 137.

In subsequent step S408, the intra-vehicle transmission and reception unit 115 transmits the invasion risk data group 137 calculated in step S407, the blind spot region information, the moving object information, and the like to the HMI device group 8. The HMI device group 8 performs the information notification from the traveling control device 100 to the driver and the occupant, the output of the warning regarding the risk of hindering travel of the vehicle 2, and the like. In subsequent step S409, the invasion risk calculation unit 113 transmits the invasion risk data group 137 calculated in step S407 to the traveling control planning unit 114, and ends the processing illustrated in FIG. 8. The traveling control planning unit 114 generates the control information for causing the vehicle 2 to travel safely based on the transmitted risk data, and transmits the control information to the actuator group 7.

FIG. 9 is a flowchart illustrating the risk calculation processing executed by the server 4. The processing illustrated in FIG. 9 is started when the server 4 receives the acquisition request transmitted in step S401 in FIG. 8. First, in step S421, the server transmission and reception unit 11 of the server 4 extracts data around the vehicle 2 from the invasion frequent occurrence region data group 33 stored in the server storage unit 30 based on the positional information of the vehicle 2 included in the acquisition request received from the vehicle 2. In subsequent step S422, the server transmission and reception unit 11 transmits the invasion frequent occurrence region data group 33 around the vehicle 2 acquired in step S421 to the traveling control device 100 of the vehicle 2, and ends the processing illustrated in FIG. 9.

### Operation Examples

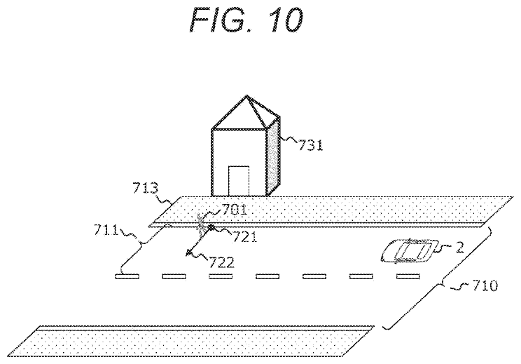

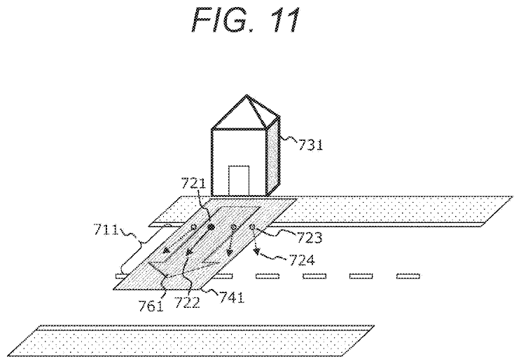

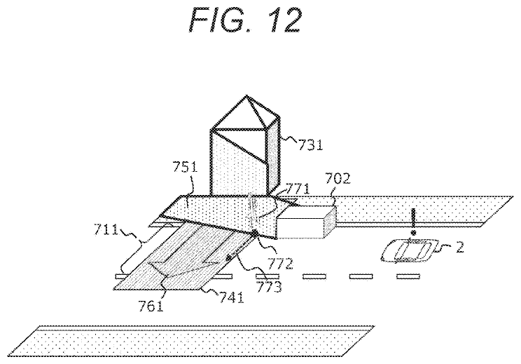

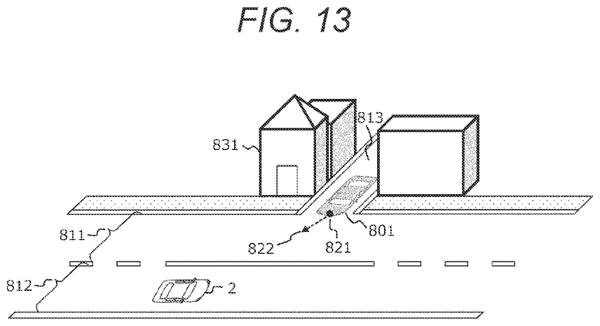

A first operation example will be described with reference to FIGS. 10 and 11, the invasion risk calculation processing will be described with reference to FIG. 12, and a second operation example will be described with reference to FIGS. 13 to 15. In both the first operation example and the second operation example, specific operations of the invasion event specification unit 112, the accumulation processing unit 12, the invasion frequent occurrence region calculation unit 13, the invasion risk calculation unit 113, and the traveling control planning unit 114 of the traveling control device 100, and the accumulation processing unit 12 invasion frequent occurrence region calculation unit 13 performed in the server 4 will be described.

### First Operation Example

In FIG. 10, the host vehicle 2 travels in a lane 711 and approaches a certain building 731. In addition, a pedestrian 701 crosses the traveling road of the host vehicle 2 from an extra-roadway region 713. A flow of the knowledge acquisition processing in the traveling control device 100 will be described with reference to the scene of FIG. 10 together with the flowcharts of FIGS. 6 and 7.

First, in step S301, information regarding a road 710 detected by the external sensor group 5 mounted on the host vehicle 2, for example, a white line that determines a region of the lane 711, a position of a road edge, and the like are acquired. In subsequent step S302, information regarding the pedestrian 701 detected by the external sensor group 5 mounted on the host vehicle 2, that is, the relative position, the moving direction, the speed, and the like are acquired. In subsequent step S303, information regarding the geographic coordinate system position of the host vehicle 2 is acquired.

The invasion event specification unit 112 selects the pedestrian 701 in subsequent step S304, and determines whether or not the pedestrian 701 has invaded the lane region in step S305. In the scene of FIG. 10, it is determined that the pedestrian 701 has invaded beyond a boundary line between an in-lane region and an out-lane region at a point of reference sign 721 (S305: Y). In step S306, the invasion event specification unit 112 stores moving object information of the pedestrian 701 as the invasion event. The moving object information stored in this step is a relative position of a position indicated by reference sign 721 with the host vehicle 2 as a reference, “pedestrian” which is a moving object classification, a moving direction indicated by reference sign 722, a moving speed, any event specification information, and the like.

In subsequent step S307, the sensor information acquisition unit 111 calculates the positional information of the pedestrian 701 in the geographic coordinate system, the moving direction, and the like based on the geographic coordinate system position of the host vehicle and the positional information 721 of the pedestrian 701 acquired in step S303. In subsequent step S308, after event specification information such as an occurrence time of the lane invasion of the pedestrian 701 is added to the invasion event information, the invasion event information is transmitted to the server 4 in step S309. Since there is no other moving object information acquired in step S302, the traveling control device 100 ends this processing (S310: Y).

The knowledge acquisition processing in the server 4 will be described with reference to FIG. 11. First, in step S321, the server 4 receives the invasion event data group 135 transmitted from the host vehicle 2. In subsequent step S322, the invasion event data group 135 is accumulated in the server storage unit 30. Similarly to the scene of FIG. 10, for example, in the server 4, past invasion event information is already stored as indicated by a white circle at reference sign 723 near the building 731. The accumulation processing unit 12 stores, as the invasion event accumulation data group 32, the invasion event 721 indicated by a black circle in FIG. 11 transmitted from the host vehicle 2 in association with past lane invasion data of close positions.

In subsequent t step S323, for example, the invasion frequent occurrence region calculation unit 13 periodically calculates an invasion frequent occurrence region 741 and stores the invasion frequent occurrence region as the invasion frequent occurrence region data group 33 based on the invasion event accumulation data group 32 accumulated and stored in step S322. For example, invasion events positioned close to each other are grouped as nearby event data by a predetermined clustering method or the like. The shape of the region 741 where the moving object may invade the lane 711 and parameters (moving direction 761, moving speed, or the like) of the moving object in the region are estimated based on the positional information (721, 723, or the like), the moving direction (722, 724, or the like), the moving speed, and the like of the nearby event data. As for the shape of the event frequent occurrence region 741, for example, it is also possible to form a quadrangular region by estimating a horizontal width from the event occurrence position of the invasion event accumulation data group 32 and a vertical width from the moving direction, the moving speed, and the like. The shape of the region 741 may be a circle, an ellipse, or the like other than the quadrangle.

### (Invasion Risk Calculation Processing)

A flow of the invasion risk calculation processing will be described with reference to FIG. 12. The invasion risk is also referred to as a “moving object jumping out risk” in the following description. First, in step S401, the traveling control device 100 acquires information regarding the geographic coordinate system position of the host vehicle 2, and generates a request signal including the positional information of the host vehicle 2. The traveling control device 100 transmits the created request signal to the server 4.

In step S421, the server 4 that has received this request signal acquires the invasion frequent occurrence region data 741 around the host vehicle 2 from the server storage unit 30. In subsequent step S422, the server 4 transmits the acquired invasion frequent occurrence region data 741 to the host vehicle 2. In step S402, the traveling control device 100 acquires the invasion frequent occurrence region data 741 transmitted by the server 4 in step S422.

In subsequent step S403, in the traveling control device 100, the sensor information acquisition unit 111 acquires, as the sensor recognition data group 133, information on a blind spot region 751 that cannot be detected by the sensor near the host vehicle by the external sensor group 5. For example, in FIG. 12, a detection region of the sensor is shielded by a stationary obstacle 702, and the blind spot region 751 indicated by hatching of dark dots is generated.

In subsequent step S404, since the invasion frequent occurrence region 741 acquired in step S402 is expressed in the geographic coordinate system, the invasion risk calculation unit 113 performs coordinate transformation into relative coordinates with respect to the host vehicle 2. As a result of the coordinate transformation, the both blind spot region information 751 and the frequent occurrence region information 741 are expressed in the relative expressions with respect to the host vehicle 2. In subsequent step S405, event specification information is acquired.

In step S406, the invasion risk calculation unit 113 collates the blind spot region information 751 with the invasion frequent occurrence region 741, determines that two regions overlap with each other, and the processing proceeds to step S407. In S407, the invasion risk calculation unit 113 calculates the invasion risk based on the information on the invasion frequent occurrence region 741 from the blind spot region 751. For example, in FIG. 12, a moving direction 773 of the moving object is calculated in the same direction as the moving direction 761 of the moving object which is the information on the region 741. As the classification of the moving object in the invasion event, the classification of the moving object having a highest invasion possibility is selected, and is set to a pedestrian 771 in FIG. 12 similarly to the setting of the invasion frequent occurrence region 741.

A jumping out start point of the moving object indicated by reference sign 772 is set to any one of regions where the blind spot region 751 and the invasion frequent occurrence region 741 overlap with each other. In order to ensure safety, the jumping out start point of the moving object may be set at a position on a boundary line between the blind spot region 751 and the invasion frequent occurrence region 741 and closest to the host vehicle 2. The reason is that the boundary line of the blind spot region is dangerous at a position where the moving object is recognized for the first time, and an event can also be ensured in a case where a jumping out event occurs from a further distant place by assuming jumping out from a position closest to the host vehicle 2.

In subsequent step S408, the invasion risk calculation unit 113 transmits risk information, state information around the host vehicle 2, and the like to the HMI device group 8 in order to notify the driver of a situation notification and a warning by using the HMI device group 8. With this information, for example, it is possible to notify the driver of the obstacle 702 and the blind spot region 751 around the host vehicle 2, and to warn the driver about the classification of the moving object, the moving direction 773, and the like regarding the jumping out risk.

Finally, in step S409, the traveling control planning unit 114 plans the trajectory on which the vehicle 2 is to travel based on the invasion risk or the like generated by the invasion risk calculation unit 113, and transmits the control command value to the actuator group 7 via the intra-vehicle transmission and reception unit 115. The actuator group 7 performs appropriate control of the host vehicle 2, and can prevent collision with an assumed moving object based on, for example, information such as the jumping out start position, the jumping out direction, and the speed of the moving object. Specifically, for example, it is possible to implement risk avoidance by decelerating before the moving object reaches a nearest position where the moving object is assumed to jumping out or taking a distance within a possible range from the position where the moving object is assumed to jump out.

### Second Operation Example

In FIG. 13, the host vehicle 2 travels in a lane 812 from left to right in the drawing and approaches a certain building 831. In addition, a vehicle 801 is about to turn right from a subordination road 813 to a lane 811. Similarly to the pedestrian illustrated in FIG. 10 of the first operation example, in FIG. 13, the invasion of the vehicle 801 into the lane 811 is detected, transmitted to the server 4 as the invasion event data group 135, and accumulated and stored.

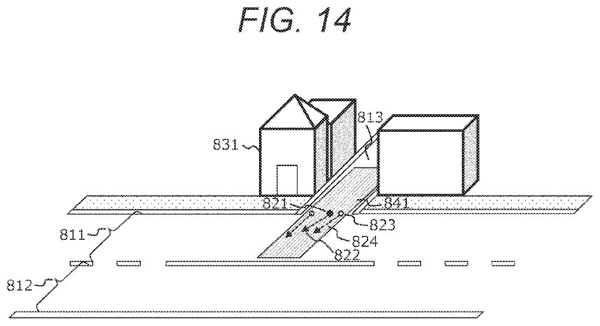

In FIG. 14, the invasion event data accumulated in the server 4 are denoted by reference signs 823 and 824, and event information newly detected in the host vehicle 2, denoted by reference signs 821 and 822, is additionally stored.

Note that, as an example different from the examples illustrated in FIGS. 13 and 14, in a case where the vehicle 801 turns left from the subordination road 813 to the lane 811 across the lane 812, two events may be recorded at a time as follows. That is, a first invasion event in which the vehicle invades the lane 811 from the subordination road 813 and a second invasion event that enters the lane 812 from the lane 811 may be recorded at a time. Further, in a case where the moving object is a vehicle and the additional information 5024 includes identifiers for specifying a lane from which the vehicle that has caused the invasion event moves and a lane to which the vehicle moves, a shape of an invasion frequent occurrence region 841 may be calculated by using information on the lane specified by the identifier.

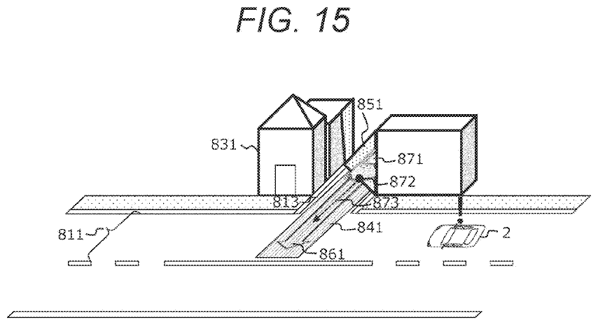

In FIG. 15, calculation processing of the invasion risk data group 137, traveling control accompanying a risk, an warning output, and the like will be described based on the invasion frequent occurrence region data group 33 calculated by the server 4 in the invasion frequent occurrence region calculation unit 13. Similarly to the first operation example, in a case where the blind spot region 851 and the invasion frequent occurrence region 841 overlap with each other, the jumping out position of the moving object is set in an overlapping region as indicated by reference sign 872, and the moving direction is also calculated as indicated by reference sign 861.

Note that the jumping out start point of the moving object indicated by reference sign 872 may be set similarly to the first operation example, but a general shape or the like of the moving object may be considered depending on the classification of the moving object. For example, in FIG. 15, in order to consider a width of a potential vehicle 871, the jumping start point 872 may be set at a position close to a center of the subordination road 813. In addition, based on the moving speed of the moving object which is one of the information on the invasion frequent occurrence region 841, for example, since a jumping out speed of the pedestrian 771 in FIG. 12 and a jumping out speed of the vehicle 871 in FIG. 14 are different, regions where the moving object can reach within a predetermined time may also be different. Therefore, in a case where the assumed moving object is a vehicle, a range of influence of the jumping out risk may be wider than in a case where the assumed moving object is a pedestrian.

Similarly to the first operation example, the invasion risk calculation unit 113 transmits the risk information, the state information around the host vehicle 2, and the like to the HMI device group 8 in order to notify the driver of the situation notification and the warning by using the HMI device group 8. Finally, similarly to the first operation example, the traveling control planning unit 114 plans a trajectory on which the vehicle 2 is to travel based on the invasion risk or the like generated by the invasion risk calculation unit 113, and transmits the control command value to the actuator group 7 via the intra-vehicle transmission and reception unit 115.

Note that the embodiment described above is an example, and the present invention is not limited thereto. That is, various applications are possible, and all embodiments are included in the scope of the present invention. For example, in the above embodiment, although the example in which the blind spot region is expressed by using the OGM has been described, a plurality of shapes of the blind spot regions may be prepared in advance and selected from among the shapes.

Furthermore, for example, in the above-described embodiment, in the traveling control device 100, it has been assumed that the kinds of processing are executed by the same processing unit and storage unit, but the kinds of processing may be executed by a plurality of different processing units and storage units. In this case, for example, processing software having a similar configuration is mounted in each storage unit, and the processing units execute the processing in a shared manner.

In addition, each processing of the traveling control device 100 is implemented by executing a predetermined operation program by using a processor and a RAM, but may be implemented by unique hardware as necessary. In addition, in the above embodiment, the external sensor group, it has been described that the vehicle sensor group, the actuator group, the HMI device group, and the external communication device are individual devices, but any two or more of these groups may be combined as necessary to implement the groups.

According to the aforementioned first embodiment, the following advantageous effects are obtained.

(1) The driving support system 1 supports the driving of the vehicle 2. The driving support system 1 includes the server storage unit 30 that stores the plurality of invasion event data groups 31 including the information on the invasion position where the moving object invades the lane region, the invasion event data group being the information on the invasion event in which the moving object invades the lane region, the on-vehicle storage unit 130 that stores the plurality of invasion event data groups 135, the invasion frequent occurrence region calculation unit 13 that specifies the invasion frequent occurrence region which is the region where the invasion event easily occurs based on the plurality of invasion event data groups 31, the sensor information acquisition unit 111 that functions as the position specification unit that specifies the position of the vehicle 2, and the driving support unit 116 that supports the driving of the vehicle by notifying the occupant of the vehicle and controlling the traveling of the vehicle based on the relationship between the invasion frequent occurrence region and the position of the vehicle. Therefore, the driving support system 1 can support the driving of the vehicle at the place where the vehicle has invaded the lane in the past.

(2) The driving support system 1 includes the invasion event specification unit 112 that detects the invasion event and records the invasion event information including the information on the invasion position. Therefore, since the driving support system 1 can create the invasion event information by itself, there is no need to receive the invasion event information from the outside.

(3) The driving support system 1 includes the sensor information acquisition unit 111 that operates as the blind spot calculation unit that calculates the blind spot region which is the region where the moving object by the external sensor group 5 mounted on the vehicle 2 is not detectable, and the invasion risk calculation unit 113 that calculates the invasion risk which is the risk of the moving object invading the lane region where the vehicle travels from the blind spot region based on the position of the vehicle, the blind spot region, and the invasion frequent occurrence region. The driving support unit 116 supports the driving of the vehicle by notifying the occupant of the vehicle or controlling the traveling of the vehicle based on the relationship between the invasion frequent occurrence region and the position of the vehicle and the invasion risk. Therefore, the driving support system 1 can perform support corresponding to the magnitude of the invasion risk of the moving object invading from the blind spot region.

(4) The driving support system 1 includes the traveling control device 100 mounted on the vehicle 2 and the server 4 set to be able to communicate with the vehicle 2. The traveling control device 100 includes the invasion event specification unit 112, the sensor information acquisition unit 111 functioning as the position specification unit, the driving support unit 116, and the in-vehicle communication unit 140 that transmits the invasion event data group 135 to the server 4 and receives the invasion frequent occurrence region data group 136 from the server 4. The server 4 includes the invasion frequent occurrence region calculation unit 13, the server storage unit 30, and the server communication unit 40 that receives the invasion event data group 135 from the traveling control device 100 and transmits the invasion frequent occurrence region data group 136 to the traveling control device 100. Therefore, the invasion frequent occurrence region can be calculated by using the information on the invasion events obtained from the plurality of vehicles, and the information on the calculated invasion frequent occurrence region can be distributed to the plurality of vehicles.

(5) The invasion event refers that the moving object invades a lane from the region other than the lane or the moving object moves from a predetermined lane to a different lane. Therefore, a lane change that is movement from a lane to a lane can also be included in the invasion event.

(6) The invasion event specification unit 112 of the driving support system 1 specifies that the moving object invades the lane based on the position of the moving object, the traveling direction of the moving object, and the region of the lane obtained by using the output of the external sensor group 5 mounted on the vehicle 2. Therefore, the invasion event specification unit 112 can detect, as the invasion event, not only a case where the moving object enters the lane but also a case where the moving object stops immediately before the lane.

(7) The invasion event specification unit 112 includes, to the invasion event information, the positional information in the geographic coordinate system in which the invasion event occurs by using the vehicle position specification unit. The invasion frequent occurrence region calculation unit 13 calculates the invasion frequent occurrence region based on the positional information in the geographic coordinate system included in the invasion event information. Therefore, the invasion frequent occurrence region calculation unit 13 can compare the occurrence positions of the plurality of invasion events by using coordinate values of the geographic coordinate system, and can determine a difference with high resolution.

(8) The invasion event information further includes, as the event specification information, at least one of the speed and the acceleration of the moving object, and the time zone in which the invasion event is detected. The invasion risk calculation unit 113 uses the event specification information for calculating the invasion risk. Therefore, the invasion risk calculation unit 113 can reflect the speed and acceleration of the moving object on the magnitude of the invasion risk to be calculated. In addition, the invasion risk calculation unit 113 can determine whether or not to use the information on the invasion event for calculating the invasion risk while referring to the information on the time zone in which the invasion event is detected. For example, in a case where there are the plurality of invasion events at the same point, the invasion risk calculation unit 113 uses only the information on the invasion event whose detected time zone is substantially the same as the current time for calculating the invasion risk.

(9) The server 4 includes the server communication unit 40 that receives the invasion event information from the vehicle different from the host vehicle 2 and stores the invasion event information in the server storage unit 30. Therefore, the invasion frequent occurrence region data created by using the invasion event information collected by other vehicles can be provided to the host vehicle 2.

### Modification Example 1

The traveling control device 100 may perform the notification control of the vehicle based on the relationship between the invasion frequent occurrence region and the position of the vehicle without calculating the blind spot or the invasion risk. For example, the traveling control device 100 may control the host vehicle 2 such that the host vehicle 2 moves away from the invasion frequent occurrence region regardless of the presence or absence of the blind spot. In addition, in a case where the distance between the host vehicle 2 and the invasion frequent occurrence region becomes equal to or less than a predetermined distance, the traveling control device 100 may notify a user by using the HMI device group 8 regardless of the presence or absence of the blind spot.

Furthermore, in this case, since the invasion risk is not calculated, the moving object information 502 may not be included in the invasion frequent occurrence region data group 136. According to Modification Example 1, it is possible to support the driving of the vehicle at a place where the vehicle has invaded the lane in the past with a simple configuration.

### Modification Example 2

In the aforementioned first embodiment, the traveling control device 100 creates the invasion event information and transmits the invasion event information to the server 4, and receives and uses the invasion frequent occurrence region data group 136 from the server 4. However, the traveling control device 100 may execute only one of creating and transmitting the invasion event information to the server 4 and receiving and using the invasion frequent occurrence region data group 136 from the server 4. For example, among 30 traveling control devices 100 communicating with the server 4, 10 traveling control devices may transmit the invasion event information and receive the invasion frequent occurrence region data group 136, 10 traveling control devices may transmit the invasion event information but not receive the invasion frequent occurrence region data group 136, and 10 traveling control devices may receive the invasion frequent occurrence region data group 136 without transmitting the invasion event information. According to Modification Example 2, even a vehicle that does not detect the invasion event can acquire the invasion frequent occurrence region data from the server 4 and use the driving support.

### Second Embodiment

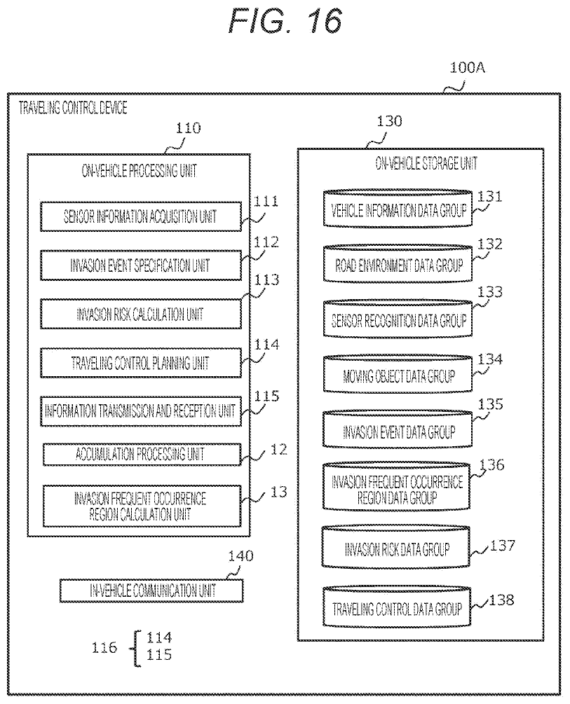

A second embodiment of the traveling control device will be described with reference to FIG. 16. In the following description, the same components as those in the first embodiment are assigned by the same reference signs, and differences will be mainly described. Points not particularly described are the same as those in the first embodiment. The present embodiment is different from the first embodiment mainly in that the processing is completed inside the vehicle.

FIG. 16 is a functional configuration diagram of a traveling control device 100A according to the second embodiment. That is, the traveling control device 100A according to the present embodiment includes an accumulation processing unit 12 and an invasion frequent occurrence region calculation unit 13 in addition to the functions in the first embodiment. In the present embodiment, the traveling control device 100A may not include an intra-vehicle transmission and reception unit 115. Operations of the accumulation processing unit 12 and the invasion frequent occurrence region calculation unit 13 are similar to those of the first embodiment.

According to the aforementioned second embodiment, the following advantageous effects are obtained.

(10) The traveling control device 100A includes the sensor information acquisition unit 111 that functions as the position specification unit that specifies the position of the vehicle, the invasion event specification unit 112 that detects the invasion event in which the moving object invades the lane and records the invasion event information including the information on the invasion position where the moving object invades the lane, the invasion frequent occurrence region calculation unit 13 that specifies the invasion frequent occurrence region which is the region where the invasion event easily occurs based on the plurality of pieces of invasion event information, and the driving support unit 116 that supports the driving of the vehicle by notifying the occupant of the vehicle or controlling the traveling of the vehicle based on the relationship between the invasion frequent occurrence region and the position of the vehicle. Therefore, the traveling control device 100A can generate the information on the invasion frequent occurrence region by itself without communicating with the server 4, and can support driving in accordance with the position of the host vehicle 2.

In the aforementioned embodiments and modification examples, the configuration of the functional block is merely an example. Some function configurations illustrated as separate functional blocks may be integrally constructed, or a configuration illustrated in one functional block diagram may be divided into two or more functions. In addition, some of the functions of each functional block may be included in another functional block.

In each of the above-described embodiments and modification examples, the program executed in the traveling control device 100 and the server 4 is stored in the ROM (not illustrated), but the program may be stored in the on-vehicle storage unit 130 and the server storage unit 30. In addition, the traveling control device 100 and the server 4 may include an input and output interface (not illustrated), and a program may be read from another device via a medium in which the input and output interface can be used as necessary. Here, the medium refers to, for example, a storage medium attachable and detachable from the input and output interface, or a communication medium, that is, a wired, wireless, or optical network, or a carrier wave or a digital signal propagating through the network. Some or all of the functions implemented by the program may be implemented by a hardware circuit or an FPGA.

The aforementioned embodiments and modification examples may be combined with each other. Although various embodiments and modification examples have been described above, the present invention is not limited to these contents. Other aspects considered within the scope of the technical idea of the present invention are also included within the scope of the present invention.

The drawings illustrate control lines and information lines considered to be necessary for describing the embodiments, and do not necessarily illustrate all the control lines and the information lines included in an actual product to which the present invention is applied. Almost all the configurations may be considered to be actually connected to each other.

### REFERENCE SIGNS LIST

1 driving support system
2 vehicle
4 server
13 invasion frequent occurrence region calculation unit
31 invasion event data group
32 invasion event accumulation data group
33 invasion frequent occurrence region data group
100, 100A traveling control device
111 sensor information acquisition unit
112 invasion event specification unit
113 invasion risk calculation unit
131 vehicle information data group
132 road environment data group
133 sensor recognition data group
135 invasion event data group
136 invasion frequent occurrence region data group
137 invasion risk data group

1. A driving support system that supports driving of a vehicle, comprising:
a storage unit that stores a plurality of pieces of invasion event information including information on an invasion position where a moving object invades a lane region which is a region of a lane, the invasion event information being information on an invasion event in which the moving object invades the lane region;
an invasion frequent occurrence region calculation unit that specifies an invasion frequent occurrence region which is a region where the invasion event easily occurs based on the plurality of pieces of invasion event information;
a position specification unit that specifies a position of the vehicle; and
a driving support unit that supports the driving of the vehicle by notifying an occupant of the vehicle and controlling traveling of the vehicle based on a relationship between the invasion frequent occurrence region and the position of the vehicle.

2. The driving support system according to claim 1, further comprising:
an invasion event specification unit that detects the invasion event, and records the invasion event information including the information on the invasion position.

3. The driving support system according to claim 1, further comprising:
a blind spot calculation unit that calculates a blind spot region which is a region where the moving object by a sensor mounted on the vehicle is not detectable by using an output of the sensor; and
an invasion risk calculation unit that calculates an invasion risk which is a risk of the moving object invading the lane region where the vehicle travels from the blind spot region based on the position of the vehicle, the blind spot region, and the invasion frequent occurrence region,
wherein the driving support unit supports the driving of the vehicle by notifying the occupant of the vehicle or controlling the traveling of the vehicle based on the relationship between the invasion frequent occurrence region and the position of the vehicle and the invasion risk.

4. The driving support system according to claim 2,
wherein the driving support system includes a traveling control device mounted on the vehicle and a server set to be able to communicate with the vehicle,
the traveling control device includes the invasion event specification unit, the position specification unit, and the driving support unit, and an on-vehicle communication unit that transmits the invasion event information to the server and receives information on the invasion frequent occurrence region from the server, and
the server includes the invasion frequent occurrence region calculation unit, the storage unit, and a server communication unit that receives the invasion event information from the traveling control device and transmits the information on the invasion frequent occurrence region to the traveling control device.

5. The driving support system according to claim 1, wherein the invasion event refers that the moving object invades the lane region from a region other than the lane region or the moving object invades a specification lane region which is a predetermined lane region from a region other than the specification lane region.

6. The driving support system according to claim 2, wherein the invasion event specification unit specifies that the moving object invades the lane based on a position of the moving object, a traveling direction of the moving object, and the lane region obtained by using an output of a sensor mounted on the vehicle.

7. The driving support system according to claim 2, wherein
the invasion event specification unit includes, to the invasion event information, positional information in a geographic coordinate system at which the invasion event occurs by using the position specification unit, and
the invasion frequent occurrence region calculation unit calculates the invasion frequent occurrence region based on the positional information of the geographic coordinate system included in the invasion event information.

8. The driving support system according to claim 3, wherein
the invasion event information further includes, as event specification information, at least one of a speed and an acceleration of the moving object, and a time zone in which the invasion event is detected, and
the invasion risk calculation unit uses the event specification information for calculating the invasion risk.

9. The driving support system according to claim 1, further comprising:
a server communication unit that receives the invasion event information from another vehicle which is a vehicle different from the vehicle and stores the invasion event information in the storage unit.

10. A traveling control device mounted on a vehicle, comprising:
a position specification unit that specifies a position of the vehicle;
an invasion event specification unit that detects an invasion event in which a moving object invades a lane region which is a region of a lane, and records invasion event information including information on an invasion position where the moving object invades the lane region;
an invasion frequent occurrence region calculation unit that specifies an invasion frequent occurrence region which is a region where the invasion event easily occurs based on the plurality of pieces of invasion event information; and
a driving support unit that supports driving of the vehicle by notifying an occupant of the vehicle or controlling traveling of the vehicle based on a relationship between the invasion frequent occurrence region and the position of the vehicle.
